(19) United States
(12) Patent Application Publication
(10) Pub. No.: US 2025/0118096 A1
(43) Pub. Date: Apr. 10, 2025

(54) LANGUAGE-BASED OBJECT DETECTION AND DATA AUGMENTATION

(71) Applicant: NEC Laboratories America, Inc., Princeton, NJ (US)

(72) Inventors: Samuel Schulter, Long Island City, NY (US); Abhishek Aich, San Jose, CA (US); Vijay Kumar Baikampady Gopalkrishna, Santa Clara, CA (US)

(21) Appl. No.: 18/904,571

(22) Filed: Oct. 2, 2024

Related U.S. Application Data
(60) Provisional application No. 63/542,393, filed on Oct. 4, 2023.
(60) Provisional application No. 63/595,405, filed on Nov. 2, 2023.
(60) Provisional application No. 63/599,163, filed on Nov. 15, 2023.

(51) Int. Cl. G06V 20/70; G06F 40/40; G06T 11/60; G06V 10/774; G06V 10/82; G06V 10/86; G06V 20/50

(52) U.S. Cl. CPC G06V 20/70; G06F 40/40; G06T 11/60; G06V 10/774; G06V 10/86; G06V 20/50; G06T 2210/12; G06V 10/82

(57) ABSTRACT

Methods and systems for object detection include generating a negative description for an input image based on a positive description of the input image using a language model. A negative image is generated based on the input image and the negative description by replacing a portion of the input image that is described by the positive description with content that is described by the negative description using a generative image model. An object detection model is trained with the input image, the positive description, the negative description, and the negative image.

### RELATED APPLICATION INFORMATION

This application claims priority to U.S. Patent Application No. 63/542,393, filed on Oct. 4, 2023, to U.S. Patent Application No. 63/595,405, filed on Nov. 2, 2023,and to U.S. Patent Application No. 63/599,163, filed on Nov. 15, 2023, each incorporated herein by reference in its entirety. This application is related to an application entitled “LANGUAGE-BASED OBJECT DETECTION AND DATA AUGMENTATION FOR SELF-DRIVING VEHICLE OPERATION,” having attorney docket number 23091, and which is incorporated by reference herein in its entirety.

### BACKGROUND

### Technical Field

The present invention relates to object detection and, more particularly, to language-based object detection.

### Description of the Related Art

Object detection is an image processing task where the locations of objects shown in an image are identified, for example by defining a bounding box around the object. Machine learning systems can be used to perform object detection, for example using a training dataset that includes images and corresponding labels that identify the objects within the training images.

Natural language can be used in object detection to describe the semantics of the image, which can significantly increase the size of the detector's label space. Natural language makes it possible to use a broad spectrum of object descriptions, ranging from generic terms like “vehicle” to specific expressions like “the red sports car parked on the left side.”

### SUMMARY

A method for object detection includes object detection include generating a negative description for an input image based on a positive description of the input image using a language model. A negative image is generated based on the input image and the negative description by replacing a portion of the input image that is described by the positive description with content that is described by the negative description using a generative image model. An object detection model is trained with the input image, the positive description, the negative description, and the negative image.

A system for object detection includes a hardware processor and a memory that stores a computer program. When executed by the hardware processor, the computer program causes the hardware processor to generate a negative description for an input image based on a positive description of the input image using a language model, to generate a negative image based on the input image and the negative description by replacing a portion of the input image that is described by the positive description with content that is described by the negative description using a generative image model, and to train an object detection model with the input image, the positive description, the negative description, and the negative image.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram showing object detection in an indoor scene, in accordance with an embodiment of the present invention;

FIG. 2 is a block diagram showing object detection using text-vision fusion, in accordance with an embodiment of the present invention;

FIG. 3 is a block/flow diagram of a method for fine-tuning a machine learning model using generated training data, in accordance with an embodiment of the present invention;

FIG. 4 is an exemplary prompt for performing recombination of noun phrases in a caption, in accordance with an embodiment of the present invention;

FIG. 5 is an exemplary prompt for summarizing the features of a positive-negative text pair, in accordance with an embodiment of the present invention;

FIG. 6 is an exemplary prompt for using a summary of positive-negative pairs to generate new pairs, in accordance with an embodiment of the present invention;

FIG. 7 is a block/flow diagram of a method for generating negative images based on a positive image with a positive caption, in accordance with an embodiment of the present invention;

FIG. 8 is a block/flow diagram of a method for training a model using augmented data, in accordance with an embodiment of the present invention;

FIG. 9 is a diagram illustrating an exemplary road scene for a self-driving vehicle, in accordance with an embodiment of the present invention;

FIG. 10 is a diagram illustrating a self-driving vehicle, in accordance with an embodiment of the present invention;

FIG. 11 is a block diagram of a computing device that can perform model training using augmented training data, in accordance with an embodiment of the present invention;

FIG. 12 is a diagram of an exemplary neural network architecture that can implement part of an object detection model, in accordance with an embodiment of the present invention;

FIG. 13 is a diagram of a deep exemplary neural network architecture that can implement part of an object detection model, in accordance with an embodiment of the present invention; and

FIG. 14 is a block/flow diagram of a method of training and using an object detection model in a self-driving vehicle, in accordance with an embodiment of the present invention.

### DETAILED DESCRIPTION OF PREFERRED EMBODIMENTS

Natural language-based object detection can incorporate both positive labels, which describe what is in the image, as well as negative labels, which describe what is not in the picture. The use of negative labels in natural language-based object detection makes it possible to use discriminative models. The negative data maya include free-form text and images. Generative models, such as large language models (LLMs) and text-to-image diffusion models can be used to automatically create relevant but contradicting object descriptions along with the corresponding images for language-based object detection.

Given an object description of a dataset, an LLM is used to generate a semantically contradicting description as the negative. In addition to changing individual words based on explicit knowledge graphs or LLMs, detection performance is improved with two alternative approaches. In a recombination approach, an LLM identifies all objects in a sentence and then creates a contradicting one by re-arranging, ignoring, or adding objects. In an in-context summary approach, an LLM is prompted to summarize the differences of positive-negative pairs collected from an existing image-level dataset. The summary is used as context to generate more such examples.

An instruction-tuned strong LLM may be used to generate positive-negative pairs, and a second LLM may be fine-tuned to generate negatives on the larger training datasets. Visual input is not needed for this step, so that powerful LLMs can be used for semantic and textual reasoning. Text-to-image diffusion models can be used to create images that match the generated negative descriptions of objects. While the direct output of such image-generation models may be noisy, or even inaccurate, filtering can be performed to reduce the noise. Having both negative object descriptions and corresponding images, discriminative loss can be improved for language-based object detection.

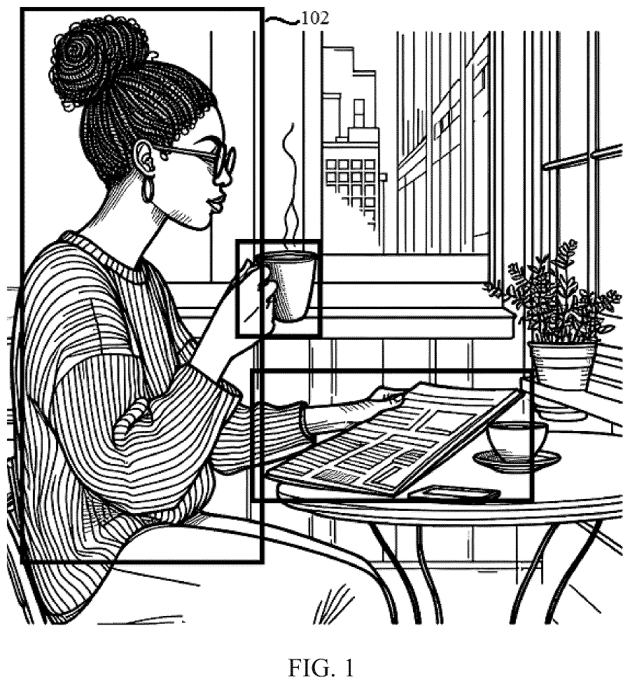

Referring now to FIG. 1, an exemplary image is shown that has had object detection performed on it. In particular, the image shows a number of bounding boxes 102 around different identified objects in the image. The image may have an accompanying natural language label that reads, “A woman is sitting at a table by a window, drinking a cup of coffee and reading a newspaper.” The bounding boxes 102 are used to identify the locations of objects mentioned in the natural language label, including the woman, the cup of coffee, and the newspaper.

Given an image and a list of object descriptions, language-based object detection seeks to output bounding boxes 102 along with scores for each description. For example, in a multi-label setting where one bounding max can map to multiple descriptions. In this example, the identified bounding box 102 may be labeled as, “person,” “woman,” and “woman reading.” An object description may refer to no objects in the image, in which case the object detection task should output an empty list.

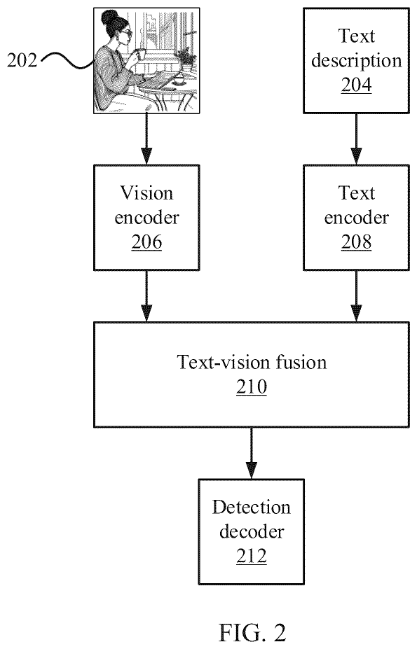

Referring now to FIG. 2, a diagram of a language-based object detection model is shown. An image 202 and a textual description 204 of the image are provided to a respective vision encoder 206 and text encoder 208. The text encoder 208 may take multiple input descriptions, for example separated by a token such as a period, and may further take single-word object descriptions. The encoders generate respective feature vectors, for example by embedding the input in a shared semantic space. In particular, the text encoder 208 takes every word in the object description and encodes it as a token, rather than summarizing the whole description into a single token.

The feature vectors are combined in text-vision fusion 210, which provides an input to detection decoder 212. The output of the detection decoder is a set of object predictions, each including a bounding box and a score for each word of the object description. Each object description can be scored by averaging the scores for all the words that make it up.

Training may include a combination of visual grounding data and object detection data (e.g., converted into grounding format). One training sample may include an image I, a text string t that includes one or more captions cₖ, and a set of L bounding boxes bₗ with word indices mₗ. The word indices in my map words in t to bounding box bₗ. The model predicts a set of bounding boxes \hat{b}ᵢ and corresponding logits \hat{p}ᵢ∈ [symbol] , where T is the number of tokens needed by the text encoder 208 to represent text t. Predictions are first matched with the ground truth via an association problem, which then enables the formulation of the classification loss as:

$$ℒ = {\sum }_{i} {ℓ}_{F L} ( {\hat{p}}_{i} , A [ σ ( i ) ] )$$

where [symbol] refers to a focal loss, σ(i) indicates the matching process and equals to l if prediction i was matched with ground truth box l. The term A∈ [symbol] is the binary alignment matrix based on the word indices mₗ. Each row corresponds to a ground truth box l and each column indicates whether a word in t refers to box bₗ. To represent negatives, an additional row in A is all zeros. If a prediction \hat{p}ᵢ is not matched with a ground truth box, then σ(i)=L points to the last row in A. Positive signals come from the words mₗ corresponding to the matched truth box bₗ and negative signals come from all other words of the text t.

The set of negatives are words in the captions of text t of an image I that do not correspond to the ground truth box bₗ. This choice may be sub-optimal, because these words may refer to entirely different objects and are easy to discriminate. Instead, the training signal may be improved by explicitly generating negative samples based off the positive descriptions to make them more relevant. Both negative text as well as corresponding negative images may be generated.

Given an object description that matches the visual content inside a bounding box, a negative description may be defined as any text that is semantically different to the original text. Good negative descriptions may still be semantically related to the original description, but should not be the same. For example, if the original description is, “Person in red shirt,” then a contradicting negative description may be, “Person in blue shirt.”

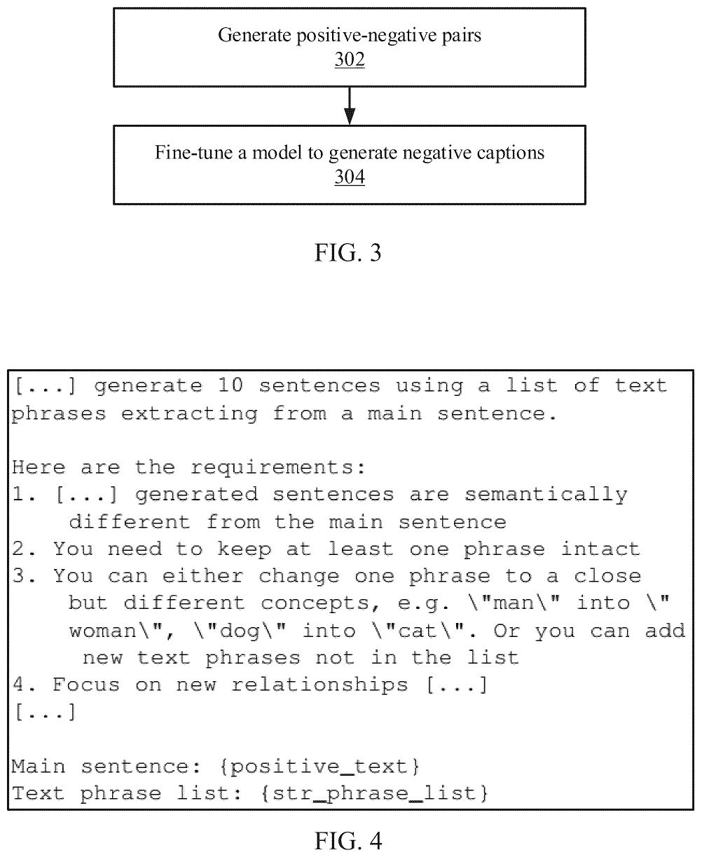

Referring now to FIG. 3, a method for training a model to generate negative captions is shown. An LLM may be used to automatically generate relevant negatives. To make the negative text generation more efficient, a strong instruction-tuned LLM may be used in block 302 to generate a large number (e.g., 50 thousand) positive-negative pairs. Block 304 may then fine-tune a model (e.g., a LLaMA-7B model) with the positive-negative pairs to generate negative captions on large grounding datasets. There are multiple options for instructing an LLM to generate positive-negative pairs of object descriptions.

In a first approach, block 302 may change individual words from the caption. The LLM may be instructed to find concepts (e.g., objects, attributes, and relationships) in object descriptions. Compared to rule-based parsers, LLMs can provide richer information. For example, in the caption, “A transportation vehicle is carrying a crowd of people who are sitting and standing,” a parser may ignore the concepts of “sitting” and “standing,” whereas an LLM may regard them as attributes. One concept may be selected from the caption and the LLM may be prompted to change it to generate a negative caption. The prompts may be manually curated with the task definition and step-by-steps for the generation.

In a second approach, block 302 may perform recombination of noun phrases. In this approach, the LLM is given more freedom in how it generates negative descriptions. Block 302 prompts the LLM to identify the objects in the original caption and to recombine them to create a new sentence different from the original caption. The LLM is allowed to ignore, change, or add objects. For example, given the caption, “A boy is playing with his dog,” and two objects, “boy” and “dog,” the LLM can output, “The girl and her dog are playing fetch in the park.”

In a third approach, block 302 may generate an in-context summary, extracting features that describe the difference between positive and corresponding negative descriptions using human-annotated positive-negative pairs. Sample pairs may be sampled from an existing dataset and the LLM may be prompted to summarize the features of the differences between the pairs. Then, instead of manually creating prompts to generate positive-negative pairs, the summary may be used together with three randomly sampled pairs as a prompt to generate them. This pipeline does not need hand-crafted prompts to explain the concept of negatives or how to create them to the LLM.

Referring now to FIG. 4, an example prompt for performing recombination of noun phrases in a caption is shown. The prompt provides natural language instructions to the LLM to guide the operation it is expected to perform.

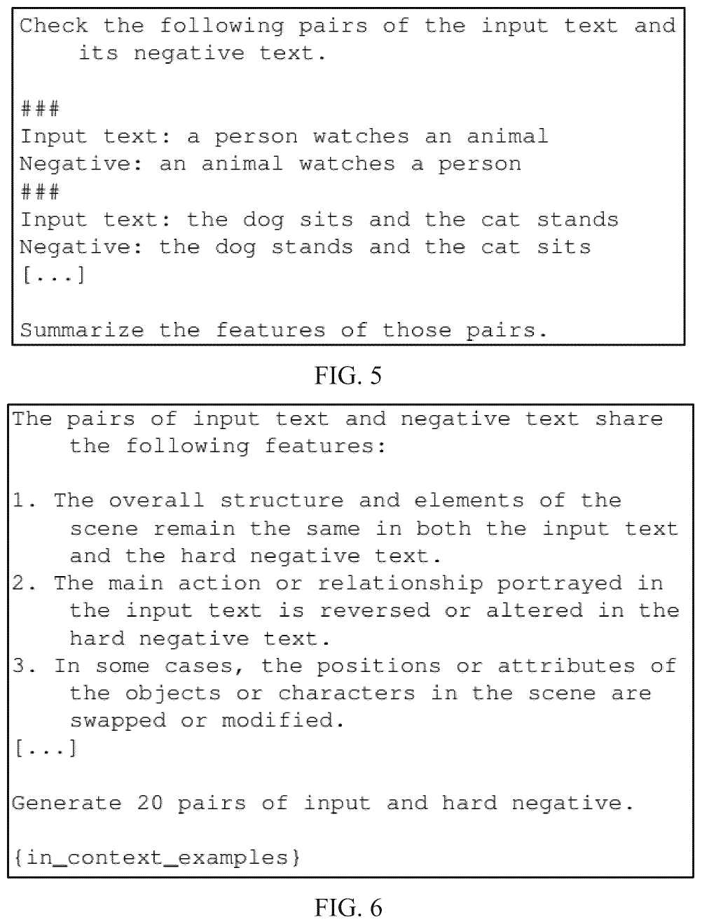

Referring now to FIG. 5, an example prompt for summarizing the features of a positive-negative text pair is shown. The prompt gives input text and a negative sample and prompts the LLM to generate features of the pairs.

Referring now to FIG. 6, an example prompt for using a summary of positive-negative pairs to generate new pairs is shown. The prompt provides a description of the summarization task and how negative text is to be generated.

Referring now to FIG. 7, a method of generating a negative image is shown. Given an original image I, a bounding box b, and a corresponding object description t, a negative image I′is defined as any image that has different semantic content inside b. The rest of the image can be equivalent to I. To obtain a negative image, visual grounding data can be used to provide bounding boxes and positive captions aligned with the bounding boxes. Block 702 turns a positive caption into a negative caption and block 704 then replaces the visual content inside the bounding box, which is associated with the original positive caption, using visual content generated by a vision language model.

Although generating negative descriptions is described above, block 702 does so in a different manner to generate negative descriptions for image generation. In this case, the generated negative text needs to preserve the alignment mₗ to the ground truth bounding box bₗ to instruct the generative image model. A bounding box bₗ may first be selected, and the corresponding words (known via mₗ) may be masked out. For example, if the selected bounding box shows a dog, then the caption, “A boy is playing with his dog,” may be masked as, “A boy is playing with [Mask].” An LLM may be used to perform this masking without reusing the original text. An in-context summary of the positive-negative pairs may then be used to generate more examples. This process may be performed twice, using a small set of manually created pairs to build the summary and then generating a lager set of similar positive-negative pairs. This can be repeated to generate a large number of examples from a summary of the generated examples. This process increases diversity in the generated data.

Given an image I, a bounding box b, and the altered text t′, block 704 generates a negative image I′ that is equal to I except in the bounding box b, where the visual content is altered to match the text t′. Using a combination of inpainting, conditioning, and text-to-image diffusion, the new visual content can be generated.

The generated images may be noisy for various reasons. For example, the altered text may refer to a large bounding box that covers other, smaller boxes. In such a scenario, large portions of the image may not match the concepts that those smaller boxes originally covered. In another example, the generated text may be noisy or meaningless, leading to unexpected visual content. In another example, the stable diffusion model may fail to understand the negative text and may generate incorrect content.

Such noisy images may be filtered by a two-step process. First, ground truth boxes bₗ may be ignored for image generation if the box covers more than a threshold percentage (e.g., greater than 75%) of other boxes in the image. Second, the semantic similarity of the generated image regions to the corresponding text can be verified. Generated images that have a similarity score to the generated negative text that is lower than a user-defined threshold may be filtered out.

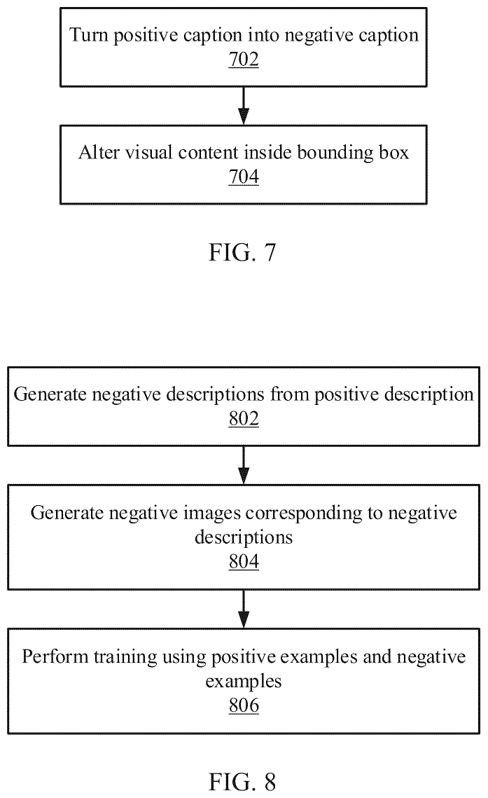

Referring now to FIG. 8, a method of learning from negative samples is shown. Having generated negative text and images, they may be integrated into training the model. Block 802 thus generates multiple negative descriptions {t′ⱼ} from a positive description t, which is taken from an original image I and which is associated with a bounding box. The image/includes bounding boxes bᵢ and indices mᵢ. A set of K>1 negative descriptions can be sampled from {t′ⱼ}. The order of the object descriptions may be shuffled to avoid biases in the location of the positive description, and they may then be concatenated into a string.

Block 804 then generates negative images corresponding to the negative descriptions. In some examples, the generated image I′ may be taken with its generated, but semantically matching, caption t′ as additional visual grounding data. The original caption t, which was the starting point to generate the negative image I′, is now used as a negative caption. In this way, both the original image I and the generated one I′ have both positive and negative descriptions.

Block 804 may alternatively pack two related samples via Mosaic augmentation to better leverage the relationship between the original data and the generated data. A new image may be created by concatenating I and I′, as well as concatenating t and t′. The box-to-word indices mᵢ may be updated accordingly. Having these sets of images and descriptions, a model may be trained in block 806.

One exemplary context in which object detection is employed is in self-driving vehicles. Self-driving vehicles need to detect objects in a scene that are relevant to driving decisions. Understanding the detailed semantics of these objects can improve safety and comfort for passengers and bystanders. Examples of such a nuanced semantic understanding would include the difference between a standard truck and an ambulance, or an ambulance with flashing lights, the difference between a car and a car with an open door, and the difference between adults, children, and the elderly. Increasing the label space when training an object detection system, for example using negative captions and negative images, improves such semantic understanding for object detection.

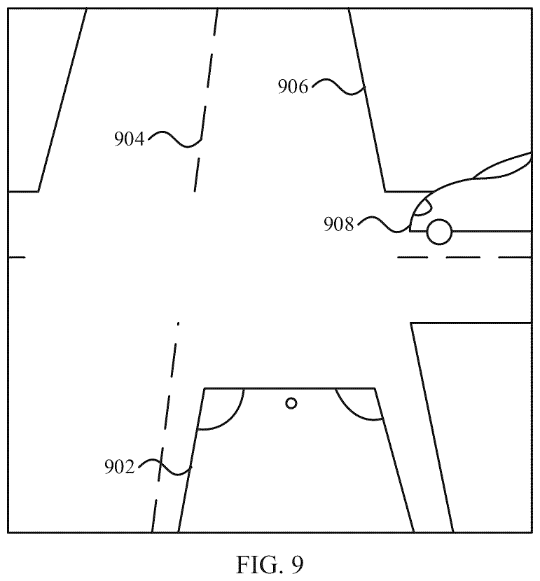

Referring now to FIG. 9, an example road scene is shown. The scene may be captured by a camera that is mounted on a vehicle 902, and may show the surroundings of the vehicle 902 from a particular perspective. It should be understood that multiple such images may be used to show various perspectives, to ensure awareness of the vehicle's entire surroundings. In some cases, a panoramic or 360° camera may be used.

Panoptic segmentation may process an image of the scene and identify different objects that are shown in the scene. For example, the segmentation may detect environmental features, such as the road boundary 906 and lane markings 904, as well as moving objects, such as other vehicles 908. Using this information, a navigation or self-driving system in the vehicle 902 can safely navigate through the scene.

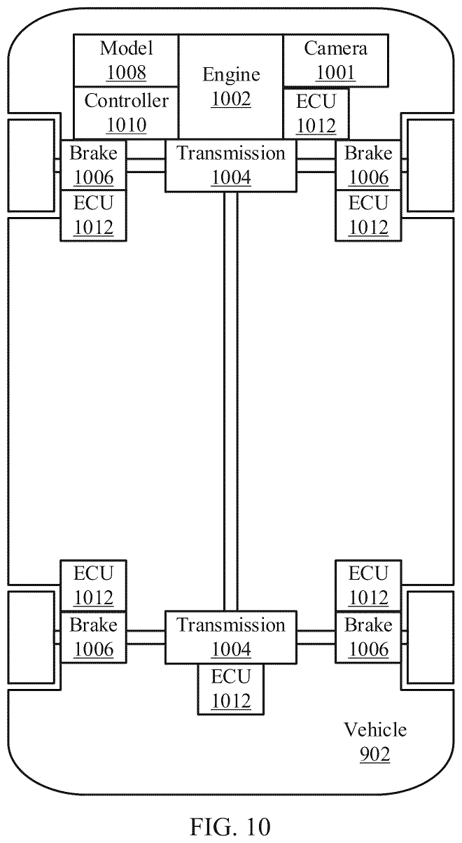

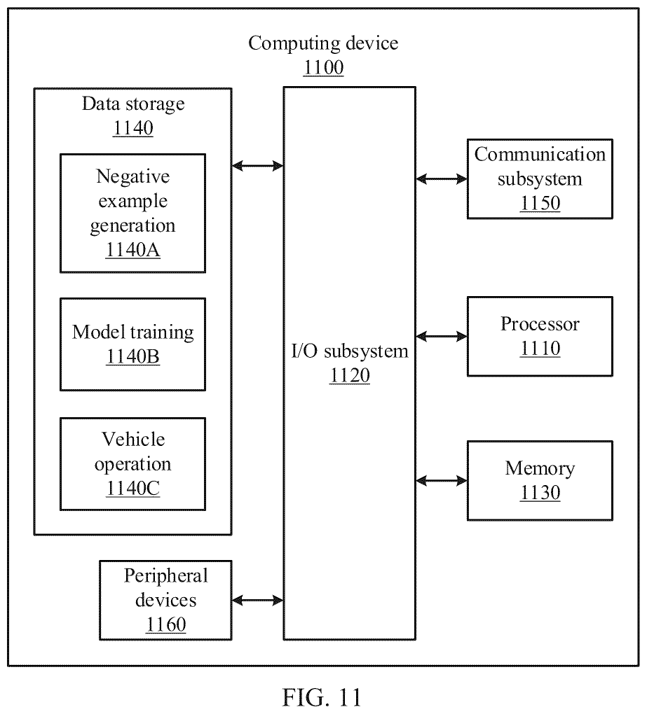

Referring now to FIG. 10, additional detail on a vehicle 902 is shown. A number of different sub-systems of the vehicle 902 are shown, including an engine 1002, a transmission 1004, and brakes 1006. It should be understood that these sub-systems are provided for the sake of illustration, and should not be interpreted as limiting. Additional sub-systems may include user-facing systems, such as climate control, user interface, steering control, and braking control. Additional sub-systems may include systems that the user does not directly interact with, such as tire pressure monitoring, location sensing, collision detection and avoidance, and self-driving.

Each sub-system is controlled by one or more equipment control units (ECUs) 1012, which perform measurements of the state of the respective sub-system. For example, ECUs 1012 relating to the brakes 1006 may control an amount of pressure that is applied by the brakes 1006. An ECU 1012 associated with the wheels may further control the direction of the wheels. The information that is gathered by the ECUs 1012 is supplied to the controller 1010. A camera 1001 or other sensor (e.g., LiDAR or RADAR) can be used to collect information about the surrounding road scene, and such information may also be supplied to the controller 1010.

Communications between ECUs 1012 and the sub-systems of the vehicle 902 may be conveyed by any appropriate wired or wireless communications medium and protocol. For example, a car area network (CAN) may be used for communication. The time series information may be communicated from the ECUs 1012 to the controller 1010, and instructions from the controller 1010 may be communicated to the respective sub-systems of the vehicle 902.

The controller 1010 uses the output of the object detection model 1008, based on information collected from cameras 1001, to identify objects and hazards within the scene. The model 1008 may, for example, output a labeled image of a road scene that is labeled according to objects and hazards that have been detected.

The controller 1010 may communicate internally, to the sub-systems of the vehicle 902 and the ECUs 1012. Based on detected road fault information, the controller 1010 may communicate instructions to the ECUs 1012 to avoid a hazardous road condition. For example, the controller 1010 may automatically trigger the brakes 1006 to slow down the vehicle 902 and may furthermore provide steering information to the wheels to cause the vehicle 902 to move around a hazard.

The model 1008 may include a language-based object detector, which need not operate on a fixed label space but that may instead use free-form object descriptions that act as categories. Standard categories, such as “car” and “person,” are still part of such object descriptions, but so are more detailed descriptions such as, “sports car on second lane to left.” A language-based object detector may be trained with free-form text and can generalize to arbitrary input text.

Language-based object detection in a mobility context can lower the cost of data management and model training by identifying and pseudo-labeling existing data logs with categories that the current detector cannot handle well, such as rare categories or highly specific ones. A language-based object detector can bypass manual human annotation via prompt engineering to identify the right text inputs to identify such objects in existing datasets. Furthermore, language-based object detection can improve safety by informing path prediction and planning. For example, nuanced differences between a parked car and a parked car with an open door makes a difference to path planning. In the latter scenario, a person may potentially exit the car, which the controller 1010 needs to account for in making safe decisions.

The model 1008 thus takes an input as an image and a list of strings that describe objects. The output is a set of bounding boxes that localize objects in the image. Each bounding box comes with a list of indices that define the object descriptions from the input text that match the bounding box, along with a confidence for each description. For example, an image may show three people, two wearing red shirts and the third wearing a green shirt. The input descriptions are, “person in red shirt” and “person in blue shirt.” The correct output would then include two bounding boxes, each with an index pointing to the first description and a high confidence score.

The model 1008 may be trained and updated using negative captions and negative images, as described above. Updating the model 1008 may include updating parameters of a neural network that implements the model 1008, for example via stochastic gradient descent optimization of a loss function that uses ground truth annotation along with input data. The training data may include pseudo labels generated by a language-based object detector. The training data may include free-form text captions to identify rare or hard-to-detect objects in vehicle data logs.

With free-form text inputs, the space of strings that are good at identifying objects can be large. Prompting can help to identify good input texts to a language-based detector for a particular category. For example, a language-based detector can return better results for a category such as, “car,” with a text input like, “A photo of a car,” or with a synonym like, “automobile.” Such prompting can be done either manually for each new category or can be performed automatically from a few example images. An optimization problem may be used to search over input text to maximize the score for a handful of manually selected examples.

Pseudo-labels may include bounding boxes along with an object description. The format for such pseudo-labels may be the same as real ground truth data for language-based object detectors, except that the pseudo-labels are generated automatically. In some cases the pseudo-labels may only be accepted if they have a confidence score from an underlying detector that exceeds a certain threshold.

One example of a downstream task for object detection is a planner, which takes output of the object detection as its input. The object detection's output may include localized objects in the scene along with semantic descriptions. With the help of more descriptive outputs, the controller 1010 can perform driving actions to maintain safety.

Referring now to FIG. 11, an exemplary computing device 1100 is shown, in accordance with an embodiment of the present invention. The computing device 1100 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 1100 may be embodied as one or more compute sleds, memory sleds, or other racks, sleds, computing chassis, or other components of a physically disaggregated computing device.

As shown in FIG. 11, the computing device 1100 illustratively includes the processor 1110, an input/output subsystem 1120, a memory 1130, a data storage device 1140, and a communication subsystem 1150, and/or other components and devices commonly found in a server or similar computing device. The computing device 1100 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 1130, or portions thereof, may be incorporated in the processor 1110 in some embodiments.

The processor 1110 may be embodied as any type of processor capable of performing the functions described herein. The processor 1110 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 1130 may be embodied as any type of volatile or non-volatile memory or data storage capable of performing the functions described herein. In operation, the memory 1130 may store various data and software used during operation of the computing device 1100, such as operating systems, applications, programs, libraries, and drivers. The memory 1130 is communicatively coupled to the processor 1110 via the I/O subsystem 1120, which may be embodied as circuitry and/or components to facilitate input/output operations with the processor 1110, the memory 1130, and other components of the computing device 1100. For example, the I/O subsystem 1120 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 1120 may form a portion of a system-on-a-chip (SOC) and be incorporated, along with the processor 1110, the memory 1130, and other components of the computing device 1100, on a single integrated circuit chip.

The data storage device 1140 may be embodied as any type of device or devices configured for short-term or long-term storage of data such as, for example, memory devices and circuits, memory cards, hard disk drives, solid state drives, or other data storage devices. The data storage device 1140 can store program code 1140A for generating negative examples, 1140B for training an object detection model using the negative examples, and/or 1140C for performing vehicle operation actions based on object detection. Any or all of these program code blocks may be included in a given computing system. The communication subsystem 1150 of the computing device 1100 may be embodied as any network interface controller or other communication circuit, device, or collection thereof, capable of enabling communications between the computing device 1100 and other remote devices over a network. The communication subsystem 1150 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 1100 may also include one or more peripheral devices 1160. The peripheral devices 1160 may include any number of additional input/output devices, interface devices, and/or other peripheral devices. For example, in some embodiments, the peripheral devices 1160 may include a display, touch screen, graphics circuitry, keyboard, mouse, speaker system, microphone, network interface, and/or other input/output devices, interface devices, and/or peripheral devices.

Of course, the computing device 1100 may also include other elements (not shown), as readily contemplated by one of skill in the art, as well as omit certain elements. For example, various other sensors, input devices, and/or output devices can be included in computing device 1100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 1100 are readily contemplated by one of ordinary skill in the art given the teachings of the present invention provided herein.

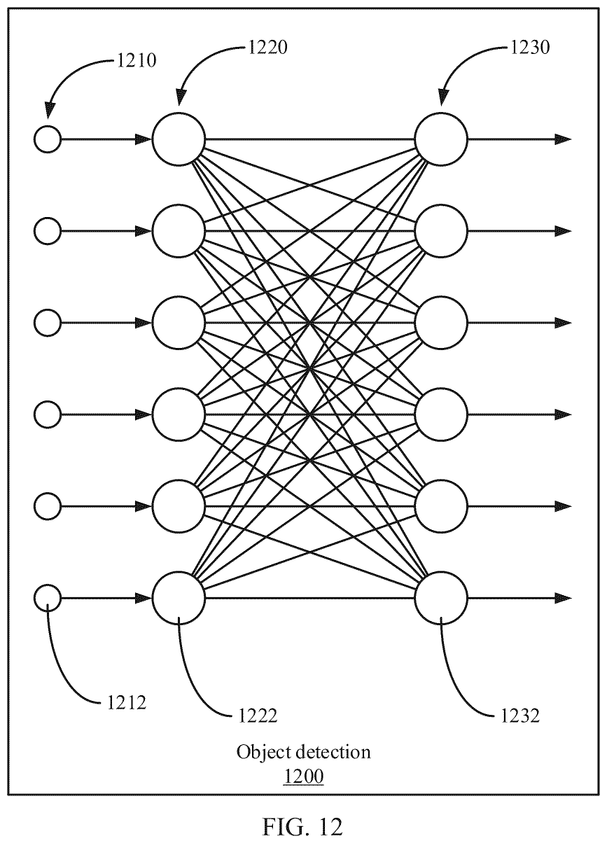

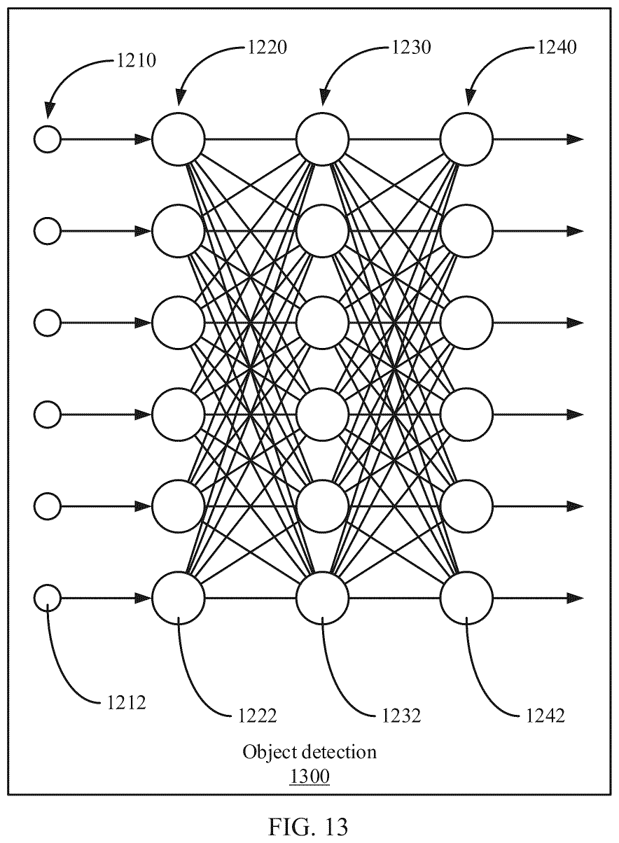

Referring now to FIGS. 12 and 13, exemplary neural network architectures are shown, which may be used to implement parts of the present models, such as the object detection model 1200/1300. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 1220 of source nodes 1222, and a single computation layer 1230 having one or more computation nodes 1232 that also act as output nodes, where there is a single computation node 1232 for each possible category into which the input example could be classified. An input layer 1220 can have a number of source nodes 1222 equal to the number of data values 1212 in the input data 1210. The data values 1212 in the input data 1210 can be represented as a column vector. Each computation node 1232 in the computation layer 1230 generates a linear combination of weighted values from the input data 1210 fed into input nodes 1220, and applies a non-linear activation function that is differentiable to the sum. The exemplary simple neural network can perform classification on linearly separable examples (e.g., patterns).

A deep neural network, such as a multilayer perceptron, can have an input layer 1220 of source nodes 1222, one or more computation layer(s) 1230 having one or more computation nodes 1232, and an output layer 1240, where there is a single output node 1242 for each possible category into which the input example could be classified. An input layer 1220 can have a number of source nodes 1222 equal to the number of data values 1212 in the input data 1210. The computation nodes 1232 in the computation layer(s) 1230 can also be referred to as hidden layers, because they are between the source nodes 1222 and output node(s) 1242 and are not directly observed. Each node 1232, 1242 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 1232 in the one or more computation (hidden) layer(s) 1230 perform a nonlinear transformation on the input data 1212 that generates a feature space. The classes or categories may be more easily separated in the feature space than in the original data space.

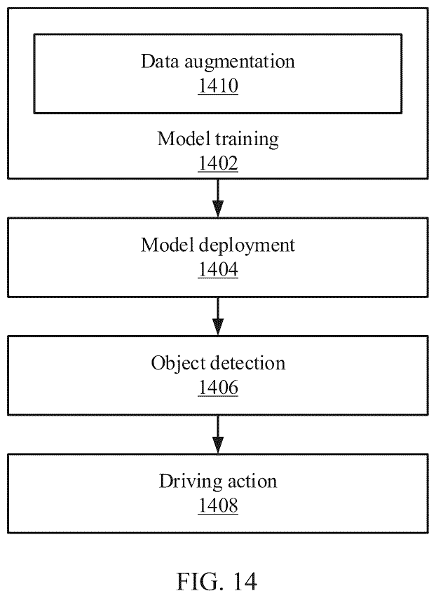

Referring now to FIG. 14, a block/flow diagram is shown of a method of training and using an object detection model in a self-driving vehicle, in accordance with an embodiment of the present invention. Block 1402 performs training of the model as described above, for example performing data augmentation 1410 using automatically generated negative captions and images before fine-tuning an object detection model. Block 1404 deploys the trained model, for example by copying parameters of the trained model to a self-driving vehicle.

Block 1406 then uses the trained model to perform object detection, for example by analyzing incoming images from a road scene to identify obstacles and other vehicles in a road scene. Block 1408 then performs a driving action responsive to the detected objects. It is specifically contemplated that the driving action may include one or more of a steering action, a braking action, an acceleration action, or any other action appropriate to respond to the detected object.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for object detection, comprising:
generating a negative description for an input image based on a positive description of the input image using a language model;
generating a negative image based on the input image and the negative description by replacing a portion of the input image that is described by the positive description with content that is described by the negative description using a generative image model; and
training an object detection model with the input image, the positive description, the negative description, and the negative image.

2. The method of claim 1, wherein training the object detection model includes using the negative description with the input image and using the positive description with the negative image as negative examples.

3. The method of claim 1, wherein generating the negative image includes identifying a bounding box associated with the positive description and replacing content within the bounding box.

4. The method of claim 3, wherein replacing content includes using inpainting, conditioning, and text-to-image diffusion based on the negative description.

5. The method of claim 1, further comprising fine-tuning the language model to generate negative descriptions based on a set of positive-negative description pairs.

6. The method of claim 5, further comprising generating the positive-negative description pairs using a second language model.

7. The method of claim 6, wherein generating the negative description includes changing a word of the positive description.

8. The method of claim 6, wherein generating the negative description includes re-combining noun phases of the positive description.

9. The method of claim 6, wherein generating the negative description includes extracting features that describe a difference between positive descriptions and corresponding negative descriptions.

10. The method of claim 1, further comprising employing the trained object detection model to identify an object within a driving scene and to perform a driving action responsive to an output of the trained object detection model.

11. A system for object detection, comprising:
a hardware processor; and
a memory that stores a computer program which, when executed by the hardware processor, causes the hardware processor to:
generate a negative description for an input image based on a positive description of the input image using a language model;
generate a negative image based on the input image and the negative description by replacing a portion of the input image that is described by the positive description with content that is described by the negative description using a generative image model; and
train an object detection model with the input image, the positive description, the negative description, and the negative image.

12. The system of claim 11, wherein the computer program further causes the hardware processor to use the negative description with the input image and using the positive description with the negative image as negative examples.

13. The system of claim 11, wherein the computer program further causes the hardware processor to identify a bounding box associated with the positive description and replacing content within the bounding box.

14. The system of claim 13, wherein the computer program further causes the hardware processor to use inpainting, conditioning, and text-to-image diffusion to replace content based on the negative description.

15. The system of claim 11, wherein the computer program further causes the hardware processor to fine-tune the language model to generate negative descriptions based on a set of positive-negative description pairs.

16. The system of claim 15, wherein the computer program further causes the hardware processor to generate the positive-negative description pairs using a second language model.

17. The system of claim 16, wherein the computer program further causes the hardware processor to change a word of the positive description.

18. The system of claim 16, wherein the computer program further causes the hardware processor to re-combine noun phases of the positive description.

19. The system of claim 16, wherein the computer program further causes the hardware processor to extract features that describe a difference between positive descriptions and corresponding negative descriptions.

20. The system of claim 11, wherein the computer program further causes the hardware processor to employ the trained object detection model to identify an object within a driving scene and to perform a driving action responsive to an output of the trained object detection model.
